(19) United States
(12) Patent Application Publication
(10) Pub. No.: US 2002/0140256 A1
(43) Pub. Date: Oct. 3, 2002

(54) Modified wheel rim articles of manufacture

(75) Inventors: Rudolph J. Stakeman JR., Terre Haute, IN (US); Jerry L. Walker, Carlisle, IN (US); Chris D. Greene, Terre Haute, IN (US); Jeffrey P. Collins, Brazil, IN (US)

Correspondence Address: JOHN W KELPER, III, 7733 FORSYTH BLVD., 12TH FLOOR, ST LOUIS, MO, 63105

(73) Assignee: The Wheel Tough Company, Inc., Terre Haute, IN (US)

(21) Appl. No.: 09/761,894

(22) Filed: Jan. 17, 2001

Related U.S. Application Data
(63) Continuation of application No. 09/057,931, filed on Apr. 9, 1998, now abandoned.

(51) Int. Cl. B60N 2/32

(52) U.S. Cl. 297/118; 297/451.6

(57) ABSTRACT

An article of manufacture constructed from modified wheel rims to provide both utilitarian and esthetically pleasing articles utilizes one or more modified wheel rims. The wheel rim modifications provide an article of manufacture with a variety of functions.

### BACKGROUND OF THE INVENTION

The present invention relates in general to articles of manufacture and pertains, more particularly, to a modified wheel rim or to a plurality of modified wheel rims constructing useful and practical products. The articles of manufacture of this invention further provide improvement over the conventional embodiments of articles of manufacture created from these or similar goods.

The conventional articles of manufacture attempt to provide facsimiles of wheel rims by copying or imitating these articles. For example, it is known to create memorabilia intended to appeal to an individual to whom the items suggest a personal hobby, pastime or pursuit.

These conventional items are constructed to imitate the article of manufacture and often fail to reproduce the ruggedness and the inherent strength and durability of the original item.

### SUMMARY OF THE INVENTION

Accordingly, it is an object of the present invention to provide an improved article of manufacture constructed from authentic wheel rims. With the articles of manufacture of this invention it has been found that the use of authentic wheel rims provide a desirable aesthetic appearance and a durable product.

Another object of the present invention is to provide an improved article of manufacture that is constructed to provide a more sturdy product from original wheel rims modified to provide the desired purposes disclosed herein and illustrated in the accompanying drawings.

A further object of the present invention is to provide an improved article of manufacture that is adapted for providing a solid product to thereby substantially reduce the user's dissatisfaction with products constructed from facsimiles of the real articles.

Still another object of the present invention is to provide an improved article of manufacture that may be readily constructed in a manner that facilitates ease of use and clean-up. The articles of manufacture of this invention are readily cleaned and shined with common household cleansers.

Still a further object of the present invention is to provide an article of manufacture that is adapted for operation or use in a variety of ways. The use of the modified wheel rims allows the user optional methods and locations of use and further provides for the option of using one or more utensils that may also be suitable for use with the invention.

Another object of the present invention is to provide an article of manufacture that requires only known welding, fastening and manufacturing techniques to construct the finished product.

To accomplish the foregoing and other objects of this invention there is provided a variety of articles of manufacture constructed from wheel rims for providing a desirable utilitarian and aesthetic functions. The cookware embodiments include the use of a single wheel rim while the furniture embodiments comprise one or more wheel rims.

The cookware embodiments comprise a wheel rim of any number of sizes adapted to receive a bottom member and a cover. The cookware embodiments include a variety of covers and associated utensils suitable for using the cookware in a variety of ways, for example, grilling, deep frying, and using the pot as a stew or soup pot.

The utensils, grates and grill arrangements are adapted for use in any of the cookware embodiments. The heat producing source for any of the cookware articles of manufacture can be located inside the article (e.g., charcoal briquettes) or outside the article (e.g., gas burner or open flame or existing bar-b-que pit).

The furniture embodiments of the present invention utilize one or more modified wheel rims to construct an aesthetically pleasing seat or stool. This embodiment of the present invention also takes advantage of the inherent strength and durability of the wheel rim to provide a functional and long lasting article.

These and other objects and features of the present invention will be better understood and appreciated from the following detailed description of embodiment thereof, selected for purposes of illustration and shown in the accompanying drawings.

### BRIEF DESCRIPTION OF THE DRAWINGS

FIG. 1 is a perspective view of one embodiment of an article of cookware constructed in accordance with the present invention from which the side, top and bottom elevations are evident;

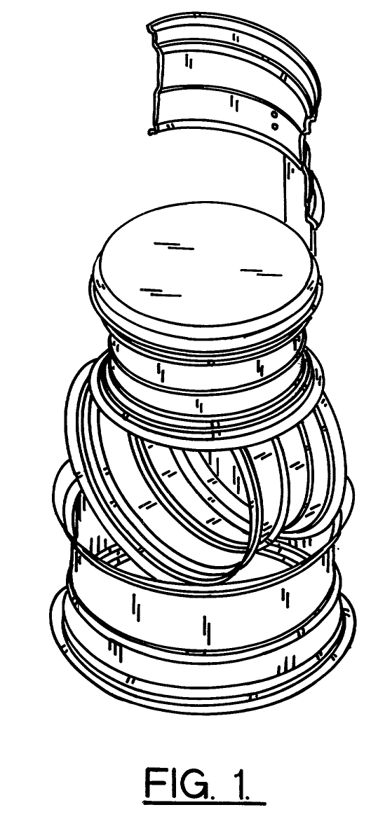

FIG. 2 is another perspective view of the article of cookware depicted in FIG. 1 with the cover moved to expose the interior of the article of cookware;

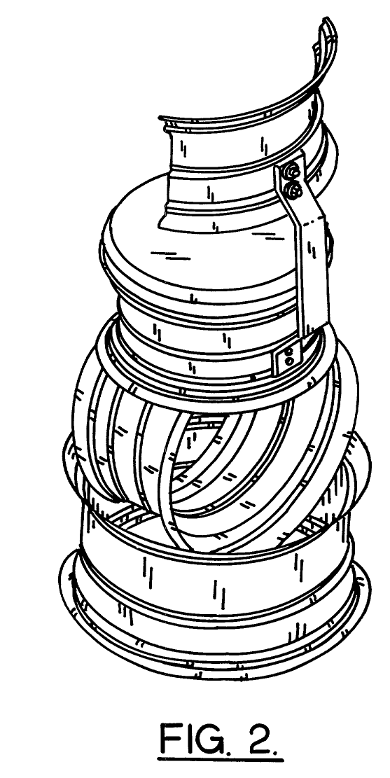

FIG. 3 is a perspective view of the cover from which the side, top and bottom elevations of the cover are evident;

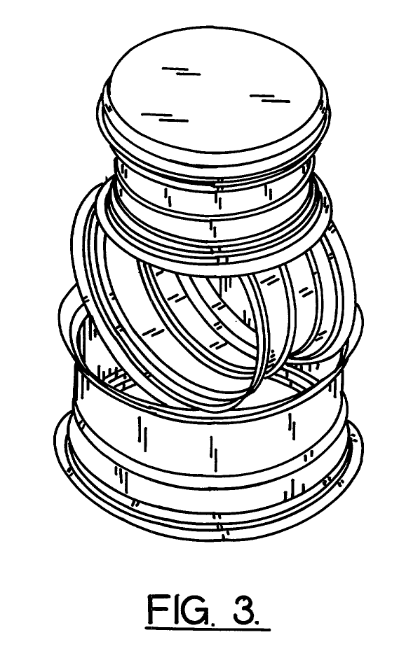

FIG. 4 is another perspective view of the article of cookware depicted in FIG. 1 with the cover removed;

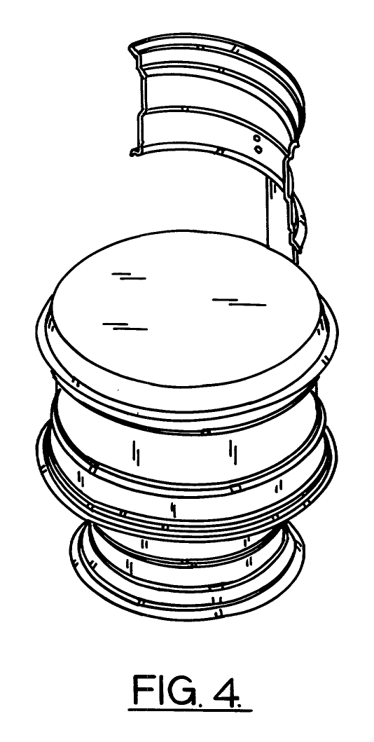

FIG. 5 is a perspective view of the cookware depicted in FIG. 1 further illustrating an embodiment of a food supporting grill and a heat source supporting grate constructed in accordance with the present invention;

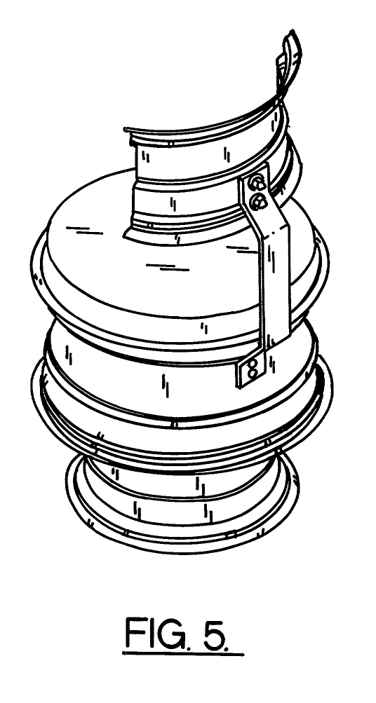

FIG. 6 is a typical cross-sectional elevational view of a wheel rim modified for purposes of the present invention, including break lines indicating the difference in height between the larger and smaller versions of the present invention and further illustrating one embodiment of a bottom opening closure utilized for the article of cookware of the present invention;

FIG. 7 is a perspective view of another embodiment of the article of cookware constructed in accordance with the present invention supported by a stand that is similar to the stand depicted in FIG. 1 with the addition of an external heat source;

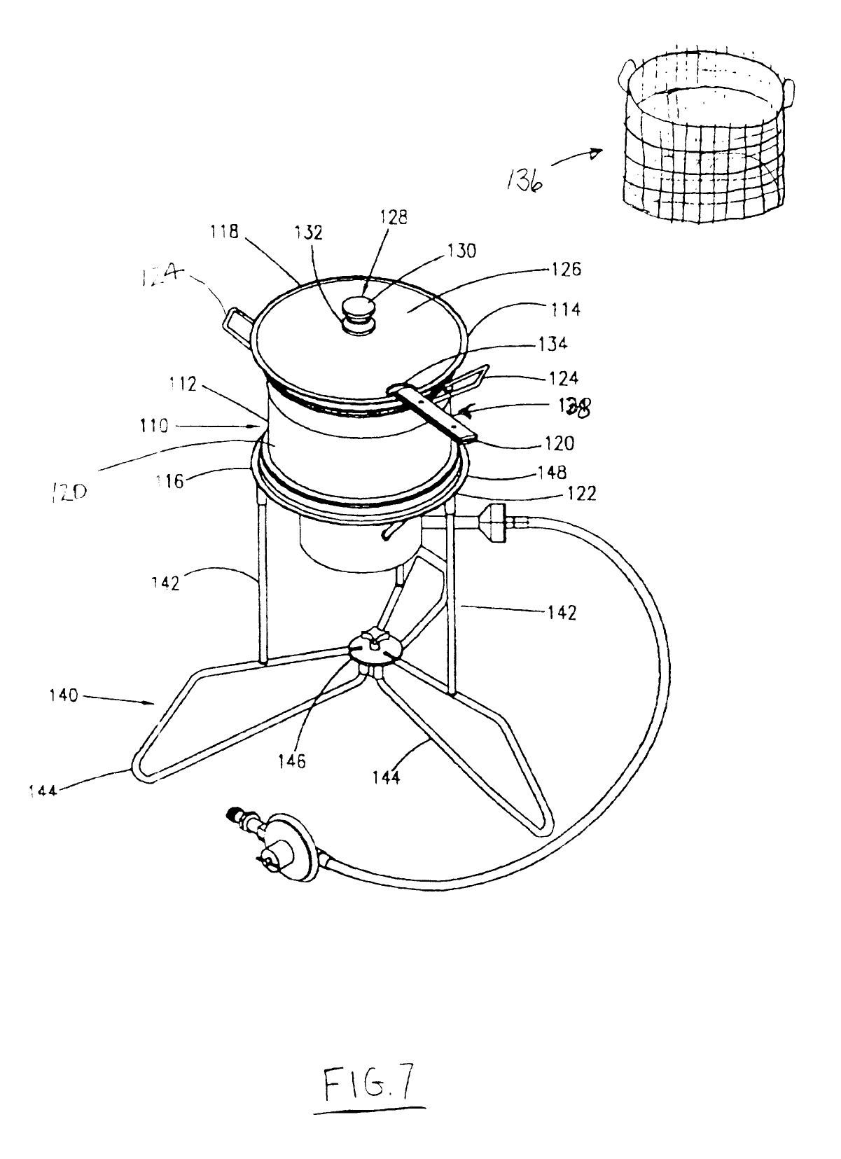

FIG. 8 is a perspective view of the external heat source and stand depicted in FIG. 1 without the external heat source and FIG. 7 with the external heat source;

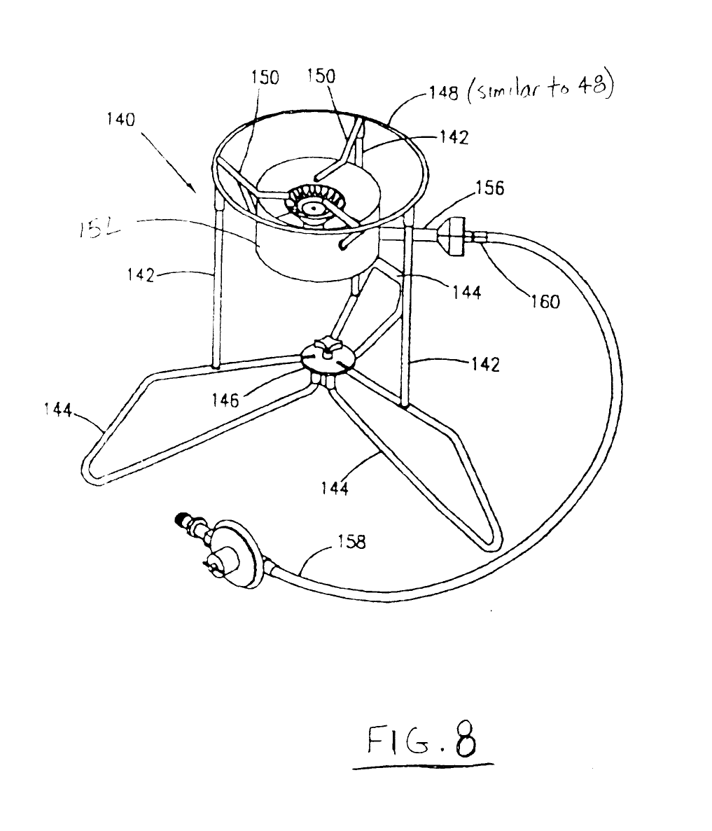

FIG. 9 is another perspective view of the stand depicted in FIG. 8;

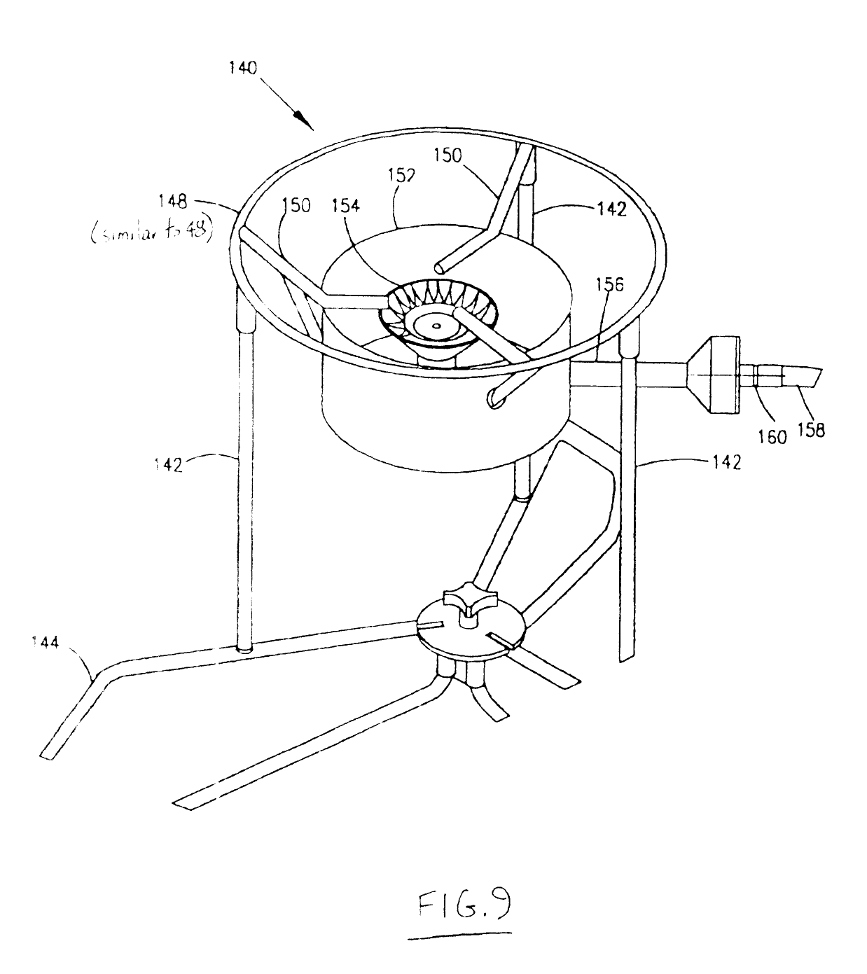

FIG. 10 is a perspective view of a food support utensil constructed in accordance with the present invention;

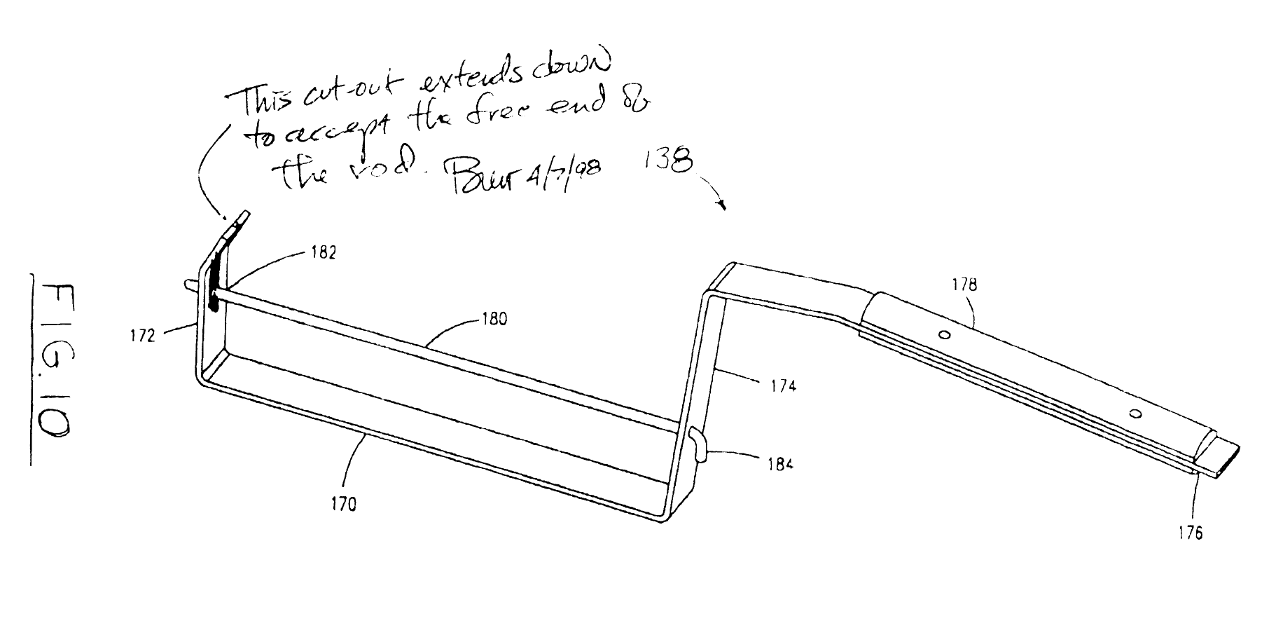

FIG. 11 is a perspective view of another article of manufacture constructed from modified wheel rims in accordance with the present invention;

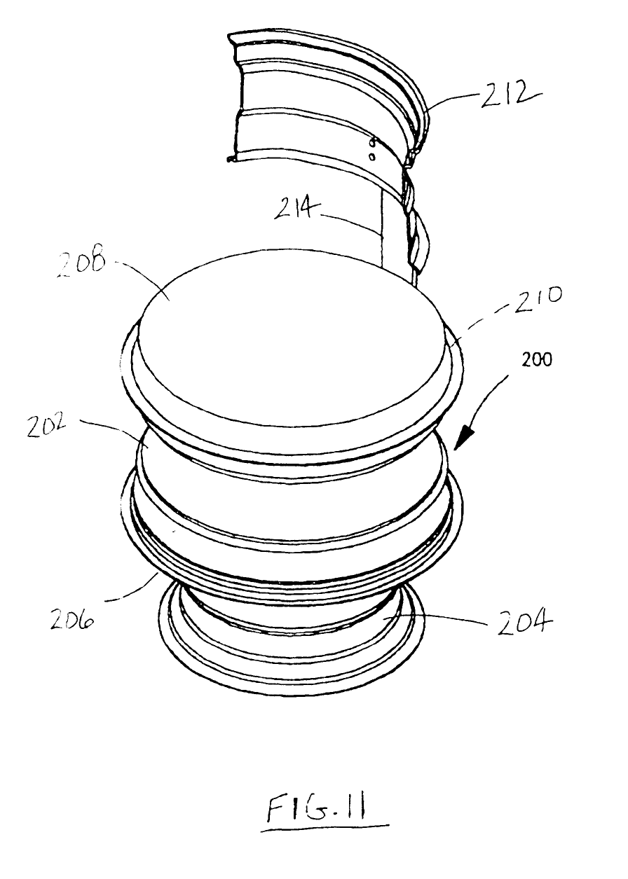

FIG. 12 is another perspective view of the article of manufacture depicted in FIG. 11;

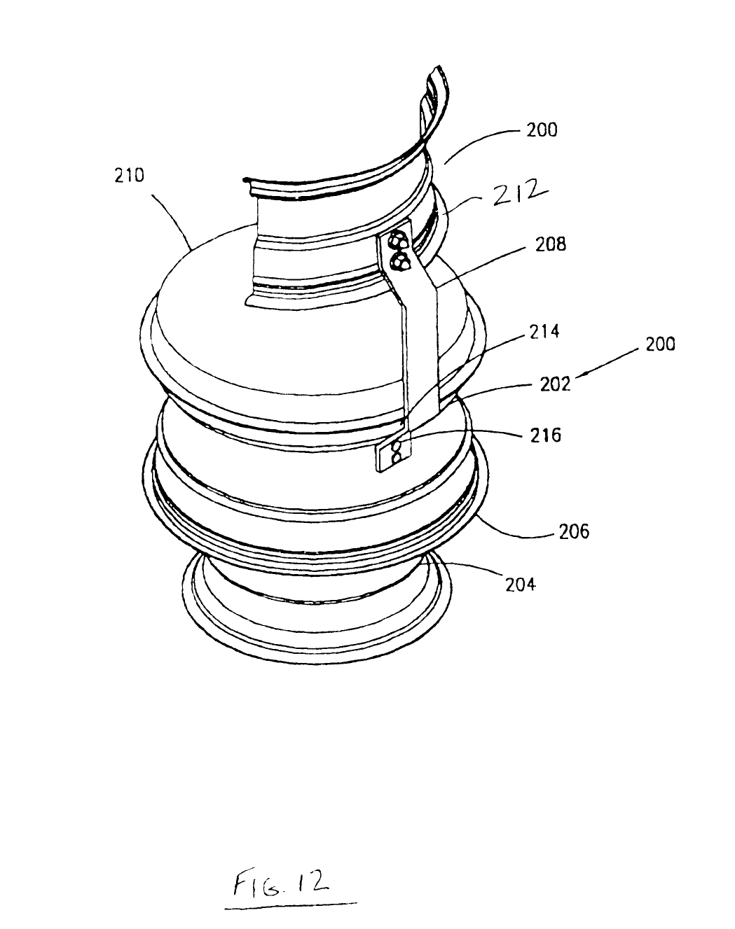

FIG. 13 is a partial perspective view of the article of manufacture depicted in FIG. 11;

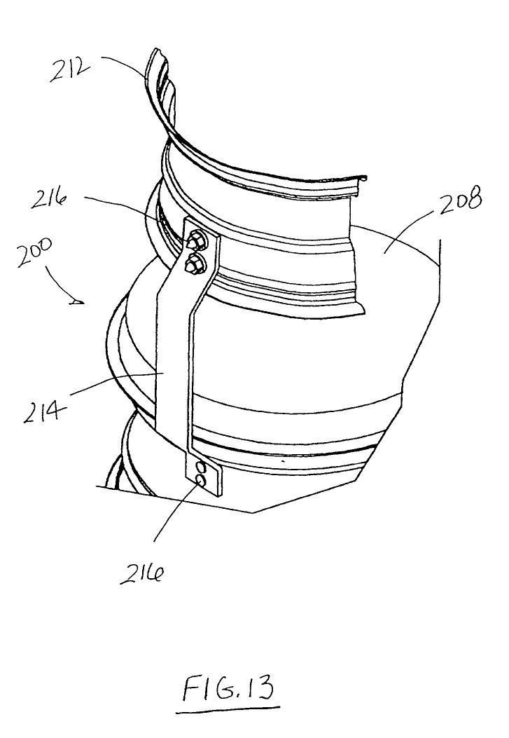

FIG. 14 is a perspective view of a backrest support bracket;

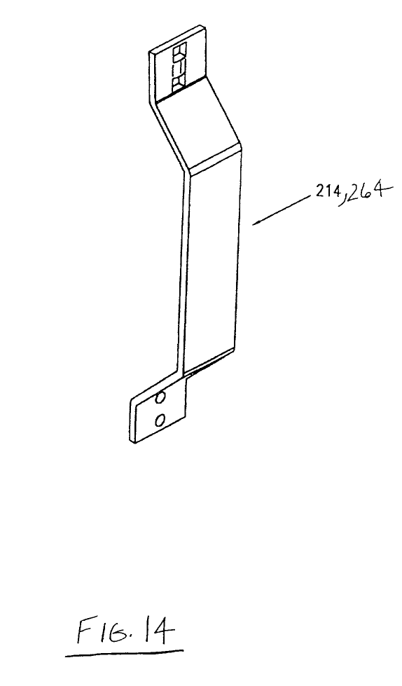

FIG. 15 is an elevational view of the backrest support bracket depicted in FIG. 14;

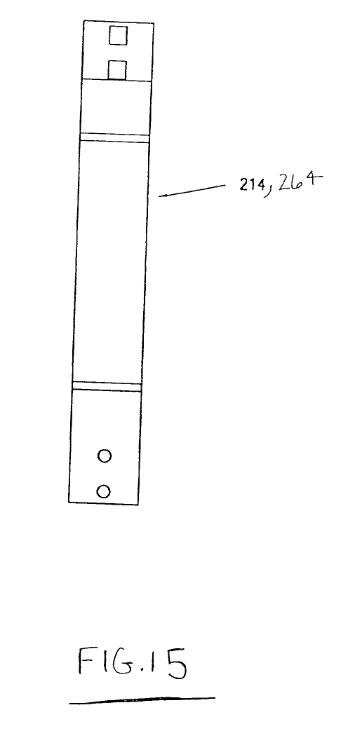

FIG. 16 is another partial perspective view of the article of manufacture depicted in FIG. 11;

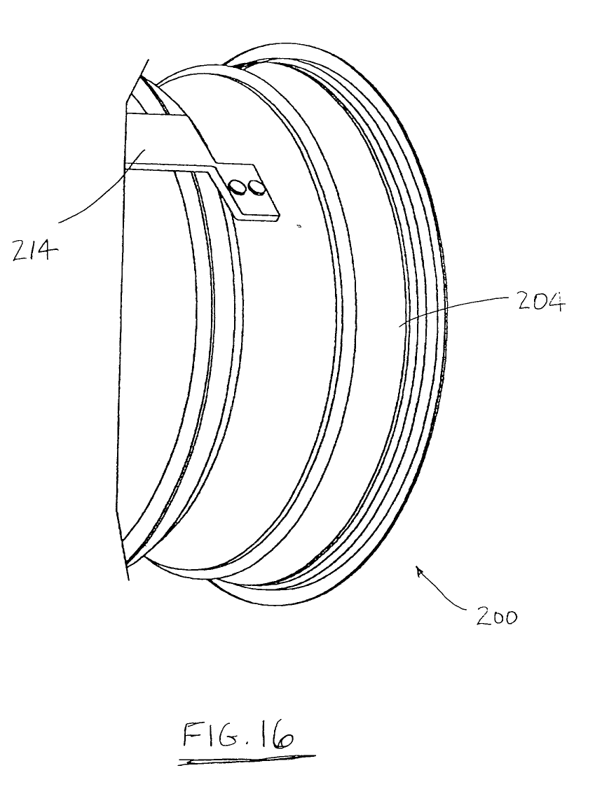

FIG. 17 is a perspective view of an additional article of manufacture constructed from modified wheel rims in accordance with the present invention; and

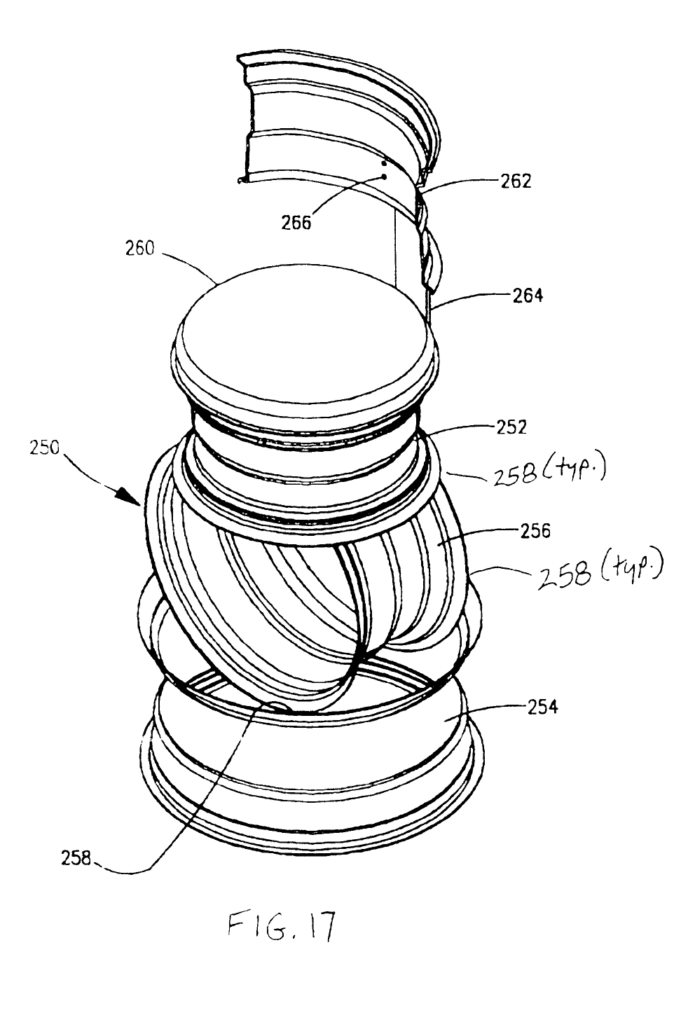

FIGS. 18-21 are additional perspective views of articles of manufacture constructed in accordance with the present invention, further illustrating the symmetrical aspects of each article of manufacture for the purpose of illustrating the ornamental design embodied within and separate from the utilitarian aspects of the present invention.

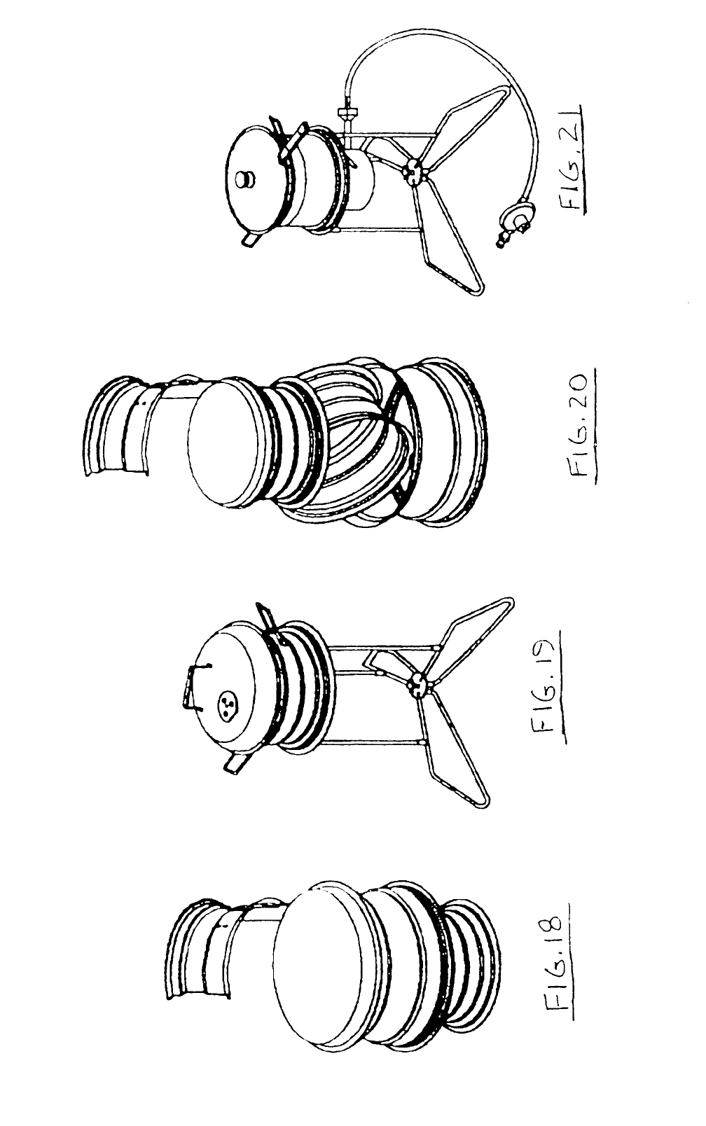

### DETAILED DESCRIPTION

Referring now to the drawings there are shown embodiments for the modified wheel rim articles of manufacture of this invention. The modified wheel rim articles of manufacture are described in connection with recreational applications to provide useful and practical products.

The articles of manufacture of the present invention are particularly adapted for providing useful and practical products contemplated to provide both utilitarian and ornamental purposes. The present invention is characterized by an aesthetically appealing article of manufacture constructed to interest the public in general and to attract an individual to whom the articles of manufacture suggest a personal hobby, pastime or pursuit.

The drawings show one modified wheel rim cookware embodiment 10 that comprises a wheel rim 12 having an upper wheel rim portion 14 and a lower wheel rim portion 16. The wheel rim cookware embodiment 10 has an inner wheel rim surface 18 and an outer wheel rim surface 20. The inner wheel rim surface 18 defines the inner volume of the cookware embodiment 10 in which the cooking process takes place.

The wheel rim cookware embodiment 10 provides for covered cooking with a closure member or lid 22. Movement of the cookware embodiment 10 is facilitated by handle member 24.

The closure member 22 is fastened to the lower wheel rim portion 16, preferably by welding. The lower closure member 22 is preferably rounded in order to collect the ash of the heat producing material used to cook the food within the cookware embodiment 10. The rounded cover 26 has a cover handle 28 and a cover handle support 30. The cover handle is attached to the rounded cover by either fasteners or welds and a wooden grip.

The rounded cover 26 includes a cover vent member 34 with cover vent members openings 36 to allow use of the cookware embodiment 10 with the cover in place over the food and the heat producing material. The cover vent member is rotatable on a cover vent shaft 30 that is attached for rotation to the rounded cover 26.

The cookware embodiment 10 can be placed in any convenient and suitable location. In addition, a collapsible cookware support stand 40 may be used to support the cookware embodiment 10 with cookware support stand vertical legs 42 and cookware support stand lower supports 44 placed on the ground or other suitable surface.

The cookware support lower supports 44 are collapsible and coupled by a cookware support stand lower support couple member 46. The cookware embodiment 10 is supported on the stand by a cookware support stand upper ring support 48.

A heat source support grate 50 is placed within the inner volume of the cookware embodiment 10 to support the wood, charcoal or other suitable heat source material.

The heat source support grate supports grate elements 52 and modified grate element support legs 54, which support the grate 50 on the bottom of the cookware embodiment 10 and, more specifically, on at least part of the closure member 22.

The rounded contour of the closure member 22 does not effect support of the heat source support grate 50 so long as the modified grate elements support legs 54 are sized accordingly. The grate elements are held together by a peripheral grate element support ring 56.

An adjustable food support grill 58 is also provided. It includes grill elements 60 and handle members 62 for lifting out and placing the food support grill within the inner wheel rim surface 18.

A plurality of grill support legs 64 are provided and shaped so as to be suitable for support on the heat source support grate 50 or on the closure member 22. The height of the grill over the heat source support grate adjusts with the location of the grill support legs, farther from the heat source if supported on the heat source support grate and closer to the heat source if supported on the bottom closure member.

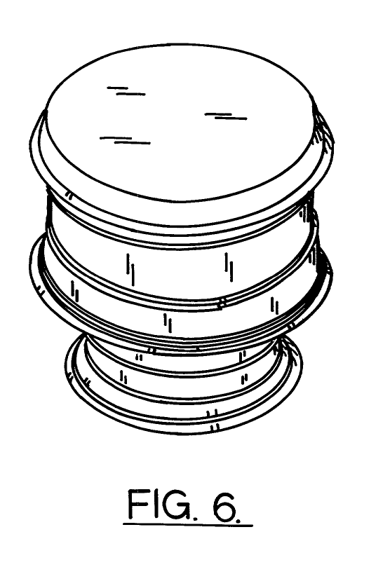

Another modified wheel rim embodiment 110 is provided by another wheel rim 112. FIG. 6 illustrates the similarity between the designs of the modified wheel rims while utilizing break lines to highlight the differences in height between the various embodiments of the present invention.

This other wheel rim 112 includes an upper wheel rim portion 114 and a lower wheel rim portion 116. The cooking portion of the cookware embodiment 110 is defined by an inner wheel rim surface 118.

There is also an outer wheel rim surface 120 to which is attached a pair of handles 124 and another bottom closure member 122, which may also be rounded. This embodiment 110 includes a flat cover member 126 with a cover handle or knob 128 for lifting the flat cover. It will be understood that a domed cover similar to the cover described above would also be suitable for this embodiment of the invention.

A knob support member 130 is attached to the flat cover 126 by either suitable fasteners or welds 132. The flat cover 126 includes a cover slot 134. In another embodiment, a wire food support basket 136, similar to a deep fryer basket, is provided or a food support utensil 138 is provided in order to cook the food in the desired manner.

Another cookware support stand 140 is provided that includes a collapsible support stand having vertical legs 142 and support stand lower supports 144. The support stand lower supports are connected by a support stand lower support couple 146.

The embodiment 110 rests on a support stand upper ring support 148, which includes inward directed support members 150 since this embodiment includes a heat source exterior to the cookware embodiment 110. The support stand further includes a burner collar 152 surrounding a burner member 154.

A burner supply pipe 156 attaches to the burner and a gas supply 158 is connected to the burner supply pipe 156 through a conventional gas supply connection 160.

In operation, the cookware embodiment 110 is useable as a deep fryer or steamer, hence the use of a food support basket 136 and, more particularly, the food support utensil 138.

The food support utensil includes a cross member 170 and an outward support 172. An inward support 174 extends into a handle portion 176. A handle portion cover 178 is provided to give some heat insulation.

A food fastening rod 180 has a free end 182 that fits into an opening on the outward support 172. This food fastening rod 180 passes through another opening in the inward support 174 and has a stopped end 184 that keeps the food fastening rod from passing through the inward support 174.

In operation, the food fastening rod is placed through, for example, an article of food to be deep fried (e.g., turkey breast, whole turkey or the like) and the utensil inward support and handle portion is placed in or through the cover slot 134 in the flat cover 126.

The versatility of the wheel rim items and the allure to facing fans is further illustrated in the double wheel rim stool 200 that includes an upper wheel rim 202 and a lower wheel rim 204. The upper and lower wheel rims are fastened by means of a weld or weldment 206 where the modified wheel rims contact each other.

A stool seat cushion is sized to fit the upper wheel rim 202 and can be left loose to allow for optional storage space 210 is attached to the upper wheel rim 202 by suitable back support bracket fasteners 216.

Another embodiment illustrated in the drawing figures depicts a triple wheel rim stool 250 comprises of an upper wheel rim 252, a lower wheel rim 254 and an intermediate wheel rim 256. The wheel rims are attached by one or more wheel rim welds 258 where the modified wheel rims contact each other.

Another stool seat cushion 250 fits into the opening of the upper wheel rim 252 and can be left loose in that opening or attached by suitable fasteners.

A back support 262 is supported by a back support bracket 264. The back support bracket is attached to the upper wheel rim 252 by suitable back support fasteners 266.

In operation, in connection with the cookware embodiments previously mentioned, the modified wheel rim cookware embodiment 10 can be used just as a conventional barbeque grill.

The other modified wheel rim embodiment 110 can be used with either the food support basket 136 or the food support utensil 138 as previously described to deep fry the desired food product. In a preferred embodiment, the modified wheel rim cookware embodiment 10 is constructed from an aluminum wheel rim of a size typically known as 17×8. The larger end of the wheel rim provides the upper wheel rim portion 14.

When the cookware embodiment 110 is used, it may be preferable to use a 15×12 wheel rim to provide more volume for the grease for the deep frying process or liquid for the steaming process. The double wheel rim stool embodiment 200 is comprised of an upper wheel rim 252 using 17×8 wheel rim and a lower wheel rim 254 that is a 15×10 wheel rim. The back rest is a section of an 18×8 wheel rim.

When the triple wheel rim stool 250 is constructed, the lower wheel rim 254 should be the 17×9.5 wheel rim, the intermediate wheel rim 256 can be a 16×8 wheel rim and the upper wheel rim 252 can be a 15×7 wheel rim.

As in the other wheel rim stool disclosed and described for purposes of illustration, the back rest or back support 262 as well as the back rest or back support of the rim stool 200 can also be a section of an 18×8 wheel rim, or an 18×7 wheel rim or a 20×8 wheel rim. It now will be understood by one skilled in the art that other size wheel rims may also be used and will still be within the scope of the present invention.

While specific embodiments have been shown and described, many variations are possible. The particular size of any of the wheel rims including the dimensions of the inner and outer surfaces may be changed or selected as desired to suit the article of manufacture to which they are used in view of the fact that available wheel rim sizes (diameter×width) include 14×7, 15×6, 15×7, 15×8, 15×10, 15×12, 16×7, 16×8, 16×9.5, 17×7, 17×8, 17×9.5, 17×11, 18×8, 18×9.5, and 20×9.5.

The wheel rim material may vary, although the authentic spun-aluminum alloy wheel rim is featured. The slightly domed bottom facilitates collection and removal or cooking grease or oil or water whether the present invention is used as a grill or a deep fryer or a steamer.

The utensils operate in conjunction with the present invention whether as food grill, grate, basket (perforated or wire) or food support utensil. The utensil, grate, grill and basket can be a steel alloy suitable for the intended purpose of food preparation and subject to the heat necessary for food preparation.

The support stand is collapsible in either illustrated configuration. A support stand with a burner requires removal of the burner before collapsing the stand.

The configuration and number of wheel rims in the stool embodiments of the articles of manufacture may vary, although it is felt that the height of the wheel rim stools will be limited by practical considerations and comfort for the user.

Also, in the embodiment, there have been various utensils, grates, baskets described. In a more simplified version of these inventions, the article of manufacture cookware embodiment may be used with various utensils.

The cookware of the present invention is useful as a grill, a deep fryer or cook pot. The cookware, utensils and accessories allow these multiple uses of the cookware of the present invention.

From the foregoing description those skilled in the art will appreciate that all of the objects of the present invention are realized. An improved article of manufacture has been shown and described for providing the desired aesthetic appearance and durability by constructing the invention from authentic wheel rims.

The original wheel rims give the present invention a sturdy construction and an appearance generally pleasing and particularly pleasing to a devotee of the sport of automotive racing. The use of the original equipment rather than inexpensive facsimiles should increase the user's enjoyment of the article of manufacture.

The improved article of manufacture is readily constructed in a manner that only requires known welding, fastening and manufacturing techniques to construct the finished product and still provides for and facilitates ease of use and clean-up. Common household cleansers and cleaning materials are sufficient to maintain the appearance of the articles of manufacture of this invention.

The use of the modified wheel rims provides a user with an article of manufacture that is adapted for operation or use in an variety of ways. The use of the modified wheel rims allows the user optional methods and locations of use and further provides for the option of using one or more utensils developed particularly for the article of manufacture or regular utensils that may also be suitable for use with the invention.

The use of the aluminum wheel rims provides rugged item of cookware with an interior volume of up to twenty-six or twenty-seven quarts for the 15×12 vessel (the 14×7 vessel, for example, is approximately 16 quarts). It is equally suitable for use at home as it is at a sporting event.

Having described the invention in detail, those skilled in the art will appreciate that modifications may be made of the invention without departing from its spirit. Therefore, it is not intended that the scope of the invention be limited to the specific embodiments illustrated and described, rather, it is intended that the scope of this invention be determined by the appended claims and their equivalents.

What is claimed is:

1. An article of manufacture, comprising:
a wheel rim, the wheel rim having a first opened end, a second opened end and an interior volume; and
a closure member attached to one or the other of the first opened end or the second opened end, whereby the wheel rim converts to a functional article of manufacture.

2. An article of manufacture as set forth in claim 1 wherein the closure member has a concave surface facing the inner volume of the wheel rim.

3. An article of manufacture as set forth in claim 1 wherein the wheel rim is supported by a stand.

4. An article of manufacture as set forth in claim 1 including a cover.

5. An article of manufacture as set forth in claim 4 wherein the cover has a concave surface.

6. An article of manufacture as set forth in claim 4 wherein the cover has a vent.

7. An article of manufacture as set forth in claim 4 wherein the cover has a handle.

8. An article of manufacture as set forth in claim 4 wherein the cover is flat.

9. An article of manufacture as set forth in claim 1 including a handle attached to the wheel rim.

10. An article of manufacture as set forth in claim 4 including a heat source support grate.

11. An article of manufacture as set forth in claim 1 including a food support grill.

12. An article of manufacture as set forth in claim 11 including a heat source support grate located beneath the food support grill.

13. An article of manufacture as set forth in claim 12 wherein the heat source support grate supports the food support grill.

14. An article of manufacture as set forth in claim 1 wherein a food support utensil supports an article of food within the wheel rim for cooking.

15. An article of manufacture as set forth in claim 14 wherein the food support utensil is a food support grate.

16. An article of manufacture as set forth in claim 14 wherein the food support utensil is a basket.

17. An article of manufacture as set forth in claim 14 wherein the food support utensil supports the article of food on a fastening member supported between an outward support and an inward support.

18. An article of manufacture as set forth in claim 14 wherein the food support utensil includes a handle portion configured to extend out of the interior volume of the wheel rim.

19. An article of manufacture as set forth in claim 3 wherein the stand includes a heat source.

20. An article of manufacture as set forth in claim 19 wherein the heat source is a combustible gas.

21. An article of manufacture as set forth in claim 3 wherein the stand supports a burner for directing a combustible gas towards the wheel rim so as to provide a heat source for cooking an article of food.

22. An article of manufacture, comprising:
a wheel rim;
a back support member; and
a back support member bracket connecting the back support member to the wheel rim.

23. An article of manufacture as set forth in claim 22 wherein the article of manufacture includes a plurality of wheel rims.

24. An article manufacture as set forth in claim 23 wherein the plurality of wheel rims are oriented in the same direction with one opening adjacent another opening.

25. An article of manufacture as set forth in claim 23 wherein the plurality of wheel rims are oriented in different directions with a sidewall of at least one wheel rims adjacent an opening of at least one other wheel rim.

26. An article of manufacture as set forth in claim 22 wherein the back support member bracket provides for yielding support of the back support member.

27. An article of manufacture as set forth in claim 23 including a seat cushion located in an opening of the wheel rim.

28. An article of manufacture as set forth in claim 27 wherein the seat cushion is affixed to the wheel rim.

29. An article of manufacture as set forth in claim 27 wherein the seat cushion is loose within the opening of the wheel rim.

30. An article of manufacture as set forth in claim 29 wherein the wheel rim and loose seat cushion form a storage area within the wheel rim.
